(19) United States
(12) Patent Application Publication
(10) Pub. No.: US 2014/0342099 A1
(43) Pub. Date: Nov. 20, 2014

(54) METHOD OF PHOTOCURING A COATING FILM

(71) Applicant: ADVANCED OPTOELECTRONIC TECHNOLOGY, INC., Hsinchu Hsien 303 (TW)

(72) Inventors: TZU-CHIEN HUNG, Hukou (TW); PO-MIN TU, Hukou (TW); CHIH-PENG HSU, Hukou (TW)

(73) Assignee: ADVANCED OPTOELECTRONIC TECHNOLOGY, INC., Hsinchu Hsien 303 (TW)

(21) Appl. No.: 14/275,905

(22) Filed: May 13, 2014

(30) Foreign Application Priority Data
May 16, 2013 (CN) 2013101815645

(51) Int. Cl. B05D 3/06

(52) U.S. Cl. CPC B05D 3/067
USPC 427/553

(57) ABSTRACT

A method of photocuring a coating film includes steps: providing a component, and coating the coating film on the component; then a pulse UV LED light source is used to irradiate the coating film to thereby solidify the coating film. During the on time of the pulse UV light source, it supplies a UV light with an enhanced intensity to the coating film to cause a top surface of the coating film to be cured quickly. Accordingly, a reaction between oxygen and free radicals in the coating film can be effectively avoided.

### BACKGROUND

1. Technical Field

The disclosure relates to a method of photocuring a coating film, and particularly to photocuring of a coating film by ultraviolet (UV) radiation.

2. Discussion of Related Art

A coating film which is to be photocured includes a photoinitiator and a curable resin. After the photocurable coating film absorbs light, free radicals are generated from the photoinitiator, and a cross-linking reaction or a polymerization is proceeded between the free radicals and the curable resin; then the coating film which is originally fluidic becomes solid to form a firm coating film on an object. The coating film has a high luster, a high hardness and a high resistance to corrosion. However, when the coating film is being cured, an oxidation reaction is also proceeded between oxygen and the free radicals to prevent the cross-linking between the free radicals and the curable resin, whereby a portion of the coating film is still in a fluidic state. The fluidic portion of the coating film could be dissolved easily in organic solvents, causing a poor stability of the coating film, even if it is photocured after a long period of time.

FIG. 1 shows a coating film manufactured by a prior photocuring method. The coating film 11 after being photocured by the prior photocuring method comprises a fluidic oxidation layer 11a, a solid layer 11b and a fluidic layer 11c, and there are a number of oxidation groups in the fluidic oxidation 11a, wherein the oxidation groups comprise hydroxyl, carboxyl, hydroperoxy radical and etc. The fluidic layer 11c will finally be cured after a period of exposure to UV radiation. However, the fluidic oxidation layer 11a still remains fluidic even after a long period of radiation by UV light. The oxidation groups can be dissolved in organic solvents, thereby reducing a stability of the coating film.

What is needed, therefore, is a method of photocuring a coating film, which can overcome the limitations described above.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present method of photocuring coating. Moreover, in the drawings, like reference numerals designate corresponding parts throughout the several views.

FIG. 1 is a cross-sectional view of a coating film manufactured by a prior method.

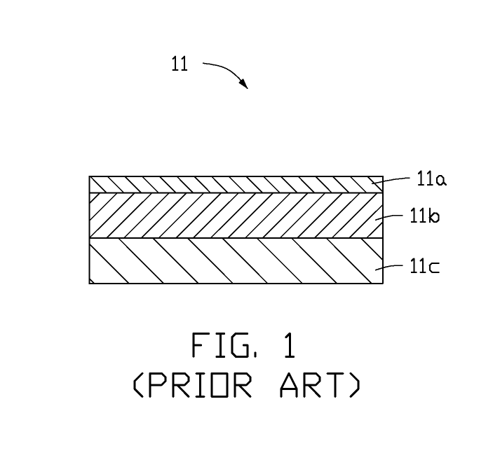

FIG. 2 is a flow chart of a method of photocuring a coating film in accordance with an exemplary embodiment of the present disclosure.

FIG. 3 is a cross-sectional view of a coating film on a component wherein the coating film is to be processed by the method of the present disclosure.

FIG. 4 is a cross-sectional view of the coating film after it is initially processed by the method in a accordance with the present disclosure.

### DETAILED DESCRIPTION OF EMBODIMENTS

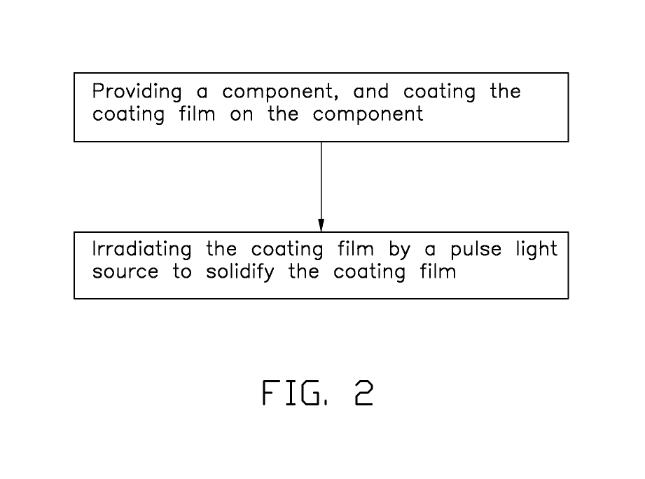

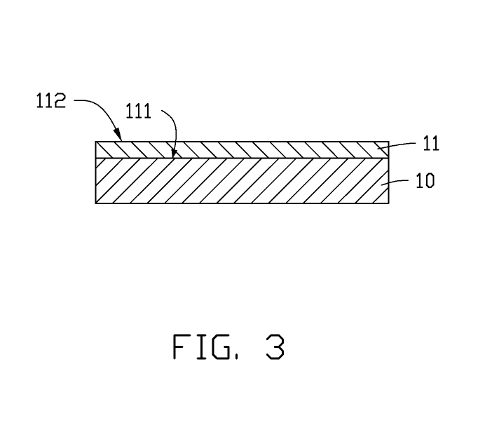

Referring to FIGS. 2 and 3, a component 10 is provided, and a photocurable coating film 11 is coated on the component 10. The component 10 is made of glass, ceramic, plastic, wood or metal. The component 10 is an object to which the coating film 11 is applied. The coating film 11 is originally fluidic and will turn into solid after absorbing enough UV radiation. A contact surface 111 of the coating film 11 is defined as a surface of the coating film 11 and engaging with the component 10, and a top surface 112 of the coating film 11 is opposite to the contact surface 111. The top surface 112 is exposed outside.

In this embodiment, a light source emitting light on the coating film 11 is a pulse UV (ultraviolet) LED (light emitting diode) light source which emits pulse ultraviolet light. The coating film 11 is a UV photocurable adhesive. The UV LED light source is turned into a pulse UV LED light source via a pulse driver which supplies pulse energy to the UV LED light source. The total energy supplied to the UV LED light source via the pulse driver is the same as that when the UV LED is used as a non-pulse UV LED light source, whereby during the on time of the pulse UV LED light source, it supplies more energy to the coating film 11. A ratio of on time and off time of the pulse UV LED light source is no more than 3:7. In the present disclosure, LED is used as the light source, since the LED light source has many advantages, such as high luminosity, low operational voltage, low power consumption, compatibility with integrated circuits, easy driving, long term reliability, and environmental friendliness.

The coating film 11 includes a photoinitiator and a curable resin. After the coating film 11 absorbs ultraviolet light, free radicals are generated from the photoinitiator, and a cross-linking reaction or a polymerization is proceeded between the free radicals and the curable resin, which results in the change of the coating film 11 from fluid to solid.

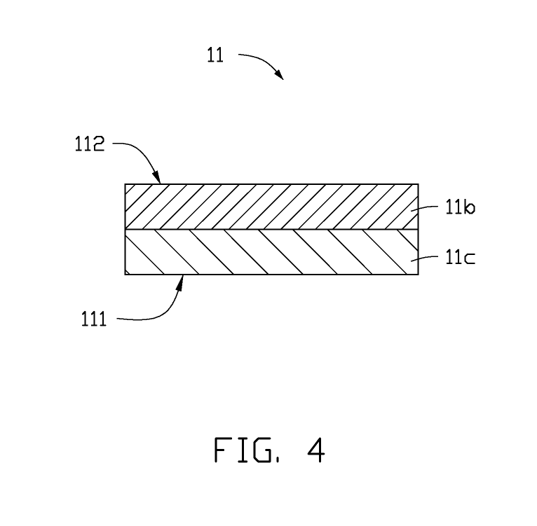

Referring to FIG. 4, the coating film 11 of the present disclosure, after an initial exposure to the UV radiation from the pulse UV LED light source includes a curable layer 11b and a fluidic layer 11c distributing from the top surface 112 to the contact surface 111. The top surface 112 is opposite to the contact surface 111 of the coating film 11, and the top surface 112 is exposed in the air. It is understood that the coating film 11 shown in FIG. 4 is under a middle stage of the photocuring process, and along with the photocuring process, the fluidic curing layer 11c is gradually cured to become solid and integrates with the cured layer 11b to become a single solid piece.

As an example, a period (i.e., pulse repetition interval) of the UV radiation the pulse UV LED light source includes 300 ms on/700 ms off, wherein the period is 1000 ms. During the on time, the pulse UV LED light source emits a UV radiation having an intensity of 50 mW/cm². During the off time, the pulse UV LED light source has no emission. The coating film 11 of the present method absorbs more energy during the on time of the pulse UV LED light source than the prior photocuring method under the condition that the prior photocuring method and the present photocuring method supply the same total light energy to the coating film during the entire photocuring process. Since in the present invention, more intensive energy is initially applied to the coating film, a cured layer can be immediately formed on a top of the coating film which can effectively prevent oxygen from entering the coating film 11 to cause an oxidation between the oxygen and the radicals below the top cured layer. Thus, a total curing of the coating film 11 can be obtained in accordance with the present disclosure.

Follows are comparison between the coatings provide by the prior method and the present method. After photocuring by absorbing the same energy in the same photocuring period, the top surface 112 of coating film is wiped by cotton wool or paper soaked in alcohol. There is a portion of the coating film which is photocured by the prior method dissolved by the alcohol in the cotton wool or paper wiping the top surface of the coating film. However, there is no portion of the coating film which is photocured in accordance with the present disclosure dissolved by the alcohol in the cotton wool or paper wiping the top surface 112 of the present coating film 11. That is, the coating film photocured by the present method has a better quality and stability.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A method of photocuring a coating film comprising:
providing a component, and coating the coating film on the component; and
irradiating the coating film by a pulse light source to solidify the coating film.

2. The method of claim 1, wherein the coating film comprises a photoinitiator and a curable resin, the photoinitiator becoming free radicals to react with curable resin when the coating film is radiated by the pulse light source.

3. The method of claim 2, wherein the coating film is an ultraviolet (UV) light-curable coating film, and the pulse light source emits pulse UV light to the coating film.

4. The method of claim 1, wherein the pulse light source is an LED light source.

5. The method of claim 4, wherein the LED light source is a UV LED light source.

6. The method of claim 4, wherein a ratio of on time and off time of the pulse light source is no more than 3:7.

7. The method of claim 6, wherein the ratio of on time and off time of the pulse light source is 3:7.

8. The method of claim 7, wherein the on time is 300 ms and off time is 700 ms.

9. The method of claim 8, wherein during the on time, the pulse light source emits light with an intensity of 50 mW/cm².
